(19) United States
(12) Patent Application Publication
(10) Pub. No.: US 2010/0124175 A1
(43) Pub. Date: May 20, 2010

(54) Apparatus and method for adaptively calculating symbolic start position

(76) Inventors: Chi-Tung Chang, Taipei City (TW); Tzu-Wen Sung, Taipei City (TW); Yu-Ling Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,223

(22) Filed: Nov. 14, 2008

(51) Int. Cl. H04J 1/16; H04L 12/56

(52) U.S. Cl. 370/250; 370/389

(57) ABSTRACT

An apparatus and a method for adaptively calculating a start position of a series of symbols are provided. The method is applied to a frame synchronization circuit that implements the apparatus for calculating the symbolic start position of a packet-switching communication system. Even under the situations such as higher frequency offset, the frequency offset value approaching zero or unstable frequency offset, the frame synchronization circuit using the claimed method still can estimate the symbolic start position. The preferred method includes a first step of retrieving the signals in a unit of packets, and calculating their delay correlation value. Next, a control circuit is incorporated to retrieve multiple groups of symbols, and to set the parameters of the systems as a basis for identifying the system's property. After that, it's to estimate the symbolic start position.

### BACKGROUND OF THE INVENTION

1. Field of the Invention

The present invention relates to an apparatus and method for adaptively calculating symbolic start position, more particularly to estimate the start position of the symbols under the circumstances of unstable frequency offset based on the parameters set by calculating the delay correlation value and comparing the relevant polarity.

2. Description of Related Art

In a packet-switching communication system, the data is transmitted in a unit of packet. The transmission therefor requires a frame and frequency synchronization, especially for receiving the packets, in order to detect the incoming packets. Meanwhile, a frame synchronization circuit is used to identify the start position of a specific symbol, so as to process the signals in the system further. Therefore, the position of the symbol used for estimating channel of the packet-switching communication system is demanded to be found.

During the demodulation for the above system, a receiver therein starts to receive data at any point in a time domain. Such as an OFDM communication system, the first action of the receiver is to detect the start position since the system's modulation process is based on the symbols. Otherwise, the error occurred to the symbolic start position will cause confusion between every two symbols, and then the symbols will be wrongfully determined. Thus the synchronization is necessary for the conventional system.

In the data received by the receiver, there are some preamble symbols—including the duplicated channel symbols, which are used to identify the start position of the OFDM system. After that, the preamble symbols are used for processing channel estimation. Reference is made to FIG. 1 showing the circuitry block of the conventional OFDM system.

According to the block diagram of the system in FIG. 1, when the data is inputted to the receiver 10 of the OFDM system, the analog-to-digital converter (ADC) 11 is used to convert the analog signals to the digital signals. Next, a symbolic start position detector 15 detects a start position from those digital signals. A FFT window controller 17 then generates a control signal for a FFT (Fast Fourier Transform) window of the above described symbols having the start position. After that, the fast Fourier transform (13) is operated on the signals converted by the ADC 11 according to the control signal for the FFT window.

According to the above-described example, after the ADC 11 converts the received signals to digital signals, the symbolic start position detector 15 detects the position for each symbol. Therefore, it finds the start position of header of the received packets. The FFT window controller 17 is to provide the information for the start position for the operation by the fast Fourier transform, so as to correctly perform the synchronization and fast Fourier transform for the signals.

Further reference is made to FIG. 2, which shows a signal frame of the conventional OFDM system. The mentioned signal is received by the receiver 10 of FIG. 1, and the signal frame is such as the frame of a wireless personal area network (WPAN). The shown signal frame includes a preamble portion 21 having the symbolic indications 1 to 24, header portion 23 and data portion 25. The signal frame for every kind of communication systems has its own specification generally. The preamble for every received signal is obtained by means of analyzing the signal frame specifically applied to the specific communication system. Therefore, the channel estimation and the relevant signal can be handled more precisely.

According to an exemplary example, some different algorithmic methods are required to process the signals before receiver outputs the meaningful data. A matching scheme is usually adopted to compare the signals in compliance with a specific format to the received signals constantly. The position of preamble may be obtained in a certain range. The start position of the header, such as the indication 201, may be found precisely after demodulating the preamble. Subsequently, the position of whole series of signals can be obtained for operating the channel estimation.

### SUMMARY OF THE INVENTION

Regarding the technology of finding the preamble symbols as processing frame synchronization in the related art, it is possible that error occurs because of frequency offset under a certain condition. In contrast, the present invention provides an apparatus and method for adaptively calculating symbolic start position to implement frame synchronization, thereby to precisely estimate the symbolic start position even though under the conditions of higher frequency offset, the frequency offset approaching zero, or unstable frequency offset. Compare with the conventional art using a means for matching to obtain the symbolic position, the method of the present invention does not find the header's position or the complete series of symbols directly, that may reduce the hardware consumption.

The apparatus for adaptively calculating symbolic start position of the present invention is primarily applied to a packet-switching communication system. A control circuit, having a delay circuit and a circuit for setting parameter, is extra introduced to enhance frame synchronization that won't be effected by the frequency offset.

The claimed method for adaptively calculating symbolic start position has a first step of calculating the real part and imaginary part of the delay correlation value of the symbols that are received externally. The absolute value of the real part compared to the imaginary part is made to set a first parameter. The chosen real part or imaginary part is used to determine the polarity of the relevant delay correlation value, and set a second parameter thereby. Next the method goes to retrieve a next group of symbols, and calculate its delay correlation value. Next, the value's real part or imaginary part is chosen according to the above-described first parameter, so as to determine the polarity. After that, the second parameter set by referring the previous group of symbols (e.g. the first group of symbols) is compared with the polarity of the delay correlation value of the current group of symbols (e.g. the second group of symbols). The result of comparison is then used to determine whether or not the polarity corresponds with the property of packet-switching communication system. Through the continuous determination of the polarity, the position of preamble symbols is obtained if the accumulated number made by a counter reaches a predetermined threshold. Therefore, the start position of a specific symbol is found after estimation.

### BRIEF DESCRIPTION OF THE DRAWINGS

The foregoing aspects and many of the attendant advantages of this invention will be more readily appreciated as the same becomes better understood by reference to the following detailed description, when set in conjunction with the accompanying drawings, wherein:

FIG. 1 shows a circuitry block diagram of a receiver of conventional OFDM system;

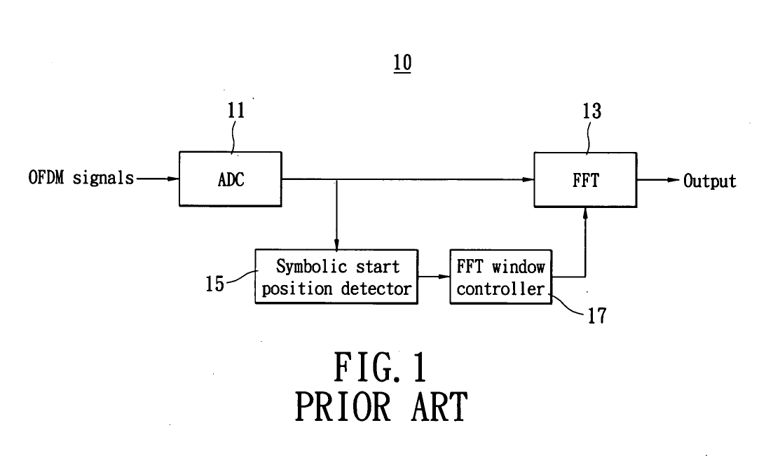

FIG. 2 shows a schematic diagram of a conventional OFDM system;

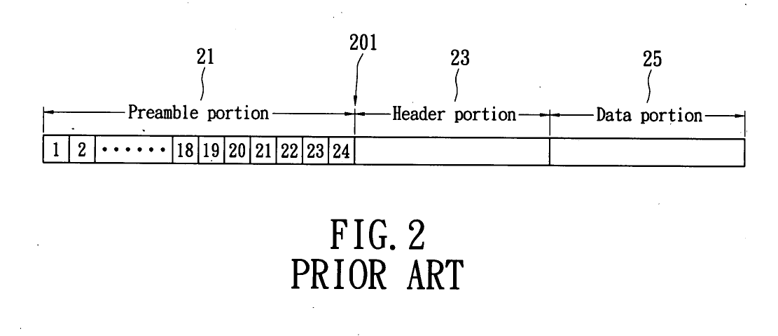

FIG. 3 is a schematic diagram of a calculation circuit for a complete series of symbols;

FIG. 4 is another schematic diagram of a calculation circuit for a complete series of symbols;

FIG. 5 shows a block diagram of apparatus for adaptively calculating symbolic start position;

FIG. 6 is a schematic diagram of symbolic polarity determination through delay correlation value;

FIG. 7 shows a flow chart of the method for adaptively calculating symbolic start position;

FIG. 8 shows a flow chart of the method for adaptively calculating symbolic start position.

### DETAILED DESCRIPTION OF PREFERRED EMBODIMENTS

The present invention is illustrated with a preferred embodiment and attached drawings. However, the invention is not intended to be limited thereby.

The present invention provides an apparatus and method for adaptively calculating the symbolic start position, the preferred embodiment is applied to the frame synchronization circuit in a packet-switching communication system, such as the wireless personal area network (WPAN). The frame synchronization circuit is used to find the start position of a specific symbol for further signal processing in the system. There are two common approaches to find the start position by referring correlation between the preamble symbols precisely. Preferably in the present invention, a delay correlation value is firstly calculated after receiving the symbols, so as to obtain the start position of channel-estimation symbols by comparing the preamble symbols.

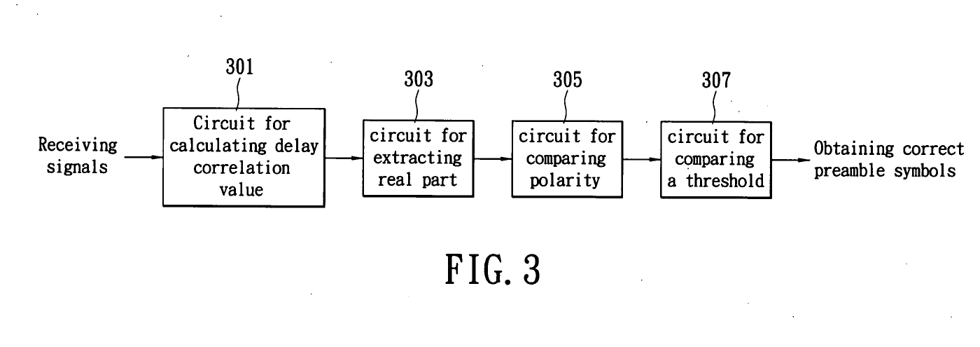

Accordingly, a calculation circuit used to find complete symbols in the first approach is shown in FIG. 3. Therein a circuit for calculating delay correlation value 301 is included for receiving signals, furthermore, a circuit for extracting real part 303, a circuit for comparing polarity 305, and a circuit for comparing a threshold 307 are included. These circuits are electrically connected therebetween in sequence, and the relation of the connections presents the operating manners for this approach.

FIG. 3 shows the signals of the communication system received by the circuit for calculating delay correlation value 301, and the delay correlation value of each symbol is calculated. Next, the circuit 303 extracts the real part of the delay correlation value by calculating the value of the each symbol or waveform thereof. After that, the circuit for comparing polarity 305 is used to determine the symbolic polarity, which represents as a plus or minus value. The polarity is compared with the calculated real part, and then to determine whether or not the polarity in compliance with the format of the communication system (set as default). This default format means the preamble symbols of the communication system have a specific format. The above comparison operation is used to compare the real part of the received symbols and the default polarity. Once the calculated real part fits in with the default value, a counter is activated to accumulate the fitting number; otherwise, if they are not consistent, the value of counter is reset. Afterward, the circuit for comparing a threshold 307 is used to determine whether or not the accumulated value reaches a predetermined threshold. If the counter's value reaches the threshold, the preamble symbols are found, and thereby to estimate the start position of the channel-estimation symbols of the system.

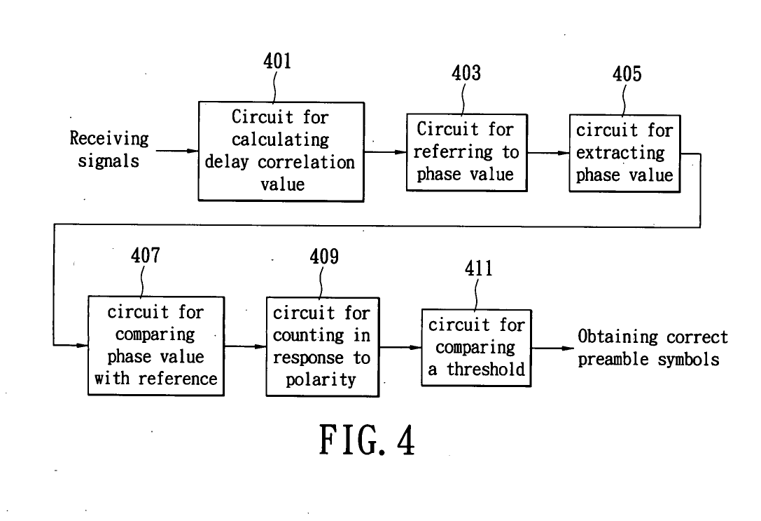

According to the mentioned second approach, the schematic diagram of the calculation circuit is shown in FIG. 4. Therein a circuit for calculating delay correlation value 401 is included to receive the signals and calculate the delay correlation value. Furthermore, a circuit for referring to phase value 403, a circuit for extracting phase value 405, a circuit for comparing phase value with reference 407, a circuit for counting in response to polarity 409 and a circuit for comparing with a threshold 411 are also included. Those circuits are electrically connected with each other in sequence, and this sequence also represents the process of receiving signals and calculating the position of the preamble symbols.

According to the second approach, the circuit 401 is used for calculating delay correlation value of symbols after receiving the signals. Next, the circuit for referring to phase value 403 is used for extracting the phase value and further sets the phase value of the delay correlation value of the extracted first group of symbols as a reference. The polarity of this first group of symbols won't be determined in this moment. But it's to calculate the delay correlation value of the subsequent extracted symbols, and the circuit for extracting phase value 405 is used to obtain their phase value. Next, the circuit for comparing phase value with reference 407 is used to discern the polarity there between, that is to compare the each symbol's phase value obtained from delay correlation value with the reference. Then all the phase values of the subsequent delay correlation value are compared with this reference.

Since the phase value is compared with the default polarity of a communication system with a specific format, if the phase value is consistent with the default value, a counter is activated to accumulate a number referring to the circuit for counting in response to polarity 409; or to reset the counter if it is not consistent. After that, the circuit for comparing a threshold 411 is used to determine whether or not the accumulated number reaches a threshold. The position of the preamble symbols is obtained if the accumulated number with consistent polarity reaches the threshold, and the start position of a specific symbol is estimated.

Reference is made to the above two approaches, the apparatus and method for adaptively calculating symbolic start position are disclosed for embodying a frame synchronization circuit that is not easily affected by some situations such as high frequency offset, the frequency offset approaching zero and unstable frequency offset. Particularly, referring to the proportional relation of the real/imaginary part of delay correlation value and the variable frequency offset, a control circuit is incorporated into the frame synchronization circuit in order to overcome the drawback of the prior art. After that, the estimating efficiency therefor won't be reduced and easily affected by frequency offset.

In general, the input signal xₙ affected by frequency offset is expressed as formula (1):

xₙ=rₙ×e^{j2πf}^{_{Δ}}^{nT}^{_{S}} (1)

wherein rₙ is the original signal without influence, f_{Δ} and T_{S} are respectively the frequency offset and sampling cycle. In order to stabilize the frequency offset of the signals, the delay correlation value is calculated as expressed in formula (2):

$$\begin{matrix}Y = {\sum }_{n = 0}^{L - 1} {x}_{n} * {x}_{n + D} {x}_{n} \\ = {\sum }_{n = 0}^{L - 1} {( {r}_{n} \times {e}^{j 2 π {f}_{Δ} {nT}_{S}} )}^{*} \times ( {r}_{n + D} \times {e}^{j 2 π {f}_{Δ} ( n + D ) {T}_{S}} ) \\ = {\sum }_{n = 0}^{L - 1} {r}_{n}^{*} \times {r}_{n + D} \times {e}^{- j 2 π {f}_{Δ} {nT}_{S}} \times {e}^{j 2 π {f}_{Δ} ( n + D ) {T}_{S}} \\ = {e}^{j 2 π {Df}_{Δ} {T}_{S}} {\sum }_{n = 0}^{L - 1} {\vert {r}_{n} \vert}^{2} .\end{matrix} \qquad ( 2 )$$

r_{n+D} is the inputted signal of the synchronization circuit after delaying D sampling points. According to formula (2), e^{j2πf}^{_{Δ}}^{T′}^{_{S}} is affected by frequency offset f_{Δ}. The phase of delay correlation value is getting bigger as the frequency offset increases. The phase of delay correlation value is getting smaller as the frequency offset approaches zero. So that, if the real part thereof is simply adopted, the real part is easily changed from plus value to minus as the frequency offset gets higher, and the estimation is then not correct. Similarly, if the phase value is simply used, the estimation is also not correct since the phase value varies easily by noise as the frequency offset approaches zero.

The circuit disclosed in the aforementioned first approach is implemented under a circumstance of the polarity of the real part of delay correlation value less changes. Therefore, some problems of transferring phase are induced by higher frequency offset if the real part of the delay correlation value is used. Since this real part has no fixed polarity, the efficiency of estimation decreases.

Further, the circuit disclosed in the second approach is implemented as the phase value of delay correlation value less changes. Similarly, this kind of circuit still works as the frequency offset gets higher. But if the phase value thereof is used as the frequency offset is lower, the efficiency of estimation decreases and the polarity of phase is induced since the phase is too small and easily affected by noise. More, when the frequency offset is unstable because the offset converges too slow, the reference is often mistaken for determination and the efficiency decreases.

In particular, the present invention provides an adaptive scheme to estimate the phase value, and further a control circuit is included to implement the frame synchronization circuit that is not easily affected by the frequency offset. In a preferred embodiment, the referred delay correlation value adopts a closest group of symbols, which is different from the mentioned circuit which refers to the phase of delay correlation value of the retrieved first group of symbols. More, it can be avoided that the reference set by delay correlation value is much different from the later delay correlation value in condition of unstable frequency offset. After that, the correct position of preamble symbols is obtained.

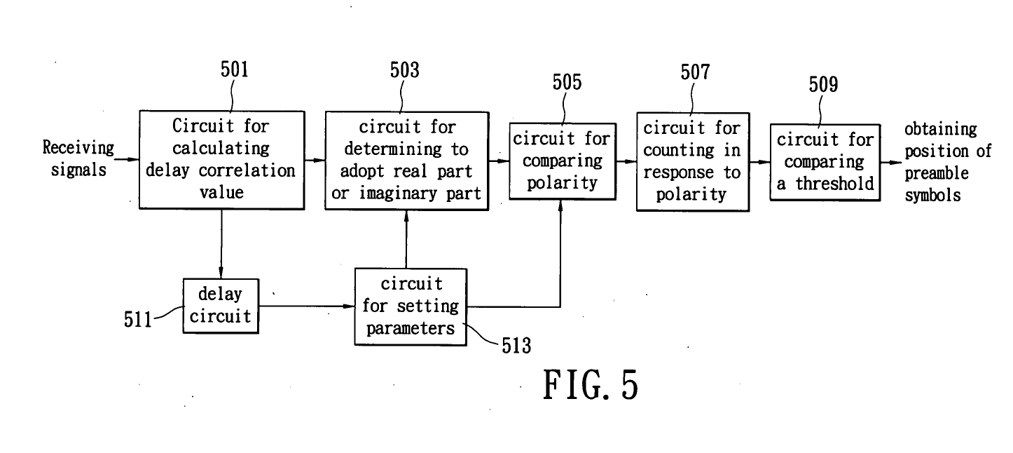

Reference is made to FIG. 5 showing an apparatus for adaptively calculating the start position of symbols of the present invention. The block diagram of circuit shows a frame synchronization circuit implemented for a specific communication system, and the operating procedure of each circuit. In which, a circuit for calculating delay correlation value 501 is included to receive the system's signals and calculate the delay correlation value of each group of symbols. A circuit for determining to adopt real part or imaginary part 503, a circuit for comparing polarity 505, a circuit for counting based on polarity 507, and a circuit for comparing with threshold 509 are included to operate the procedures of comparison and determination. The above circuits are electrically connected in sequence, and also express the process of obtaining the position of preamble symbols. Further, the embodiment thereof adds a control circuit that is electrically connected with those circuits. The control circuit includes a delay circuit 511 for storing the result of the calculation of delay correlation value, and a circuit for setting parameters 513 for setting at least two parameters for further comparison based on the delay correlation value of each group of symbols and its polarity. This embodiment particularly saves the memory used for storing a complete set of symbols, and keeps a good estimation efficiency as the frequency offset gets higher or approaches zero.

In detail, when the circuit for calculating delay correlation value 501 receives a first group of symbols, it's to calculate their delay correlation value. Next, the circuit for determining to adopt real part or imaginary part 503 is used to determine if the real part or imaginary part is adopted. According to a preferred embodiment, the absolute value of the real part and the imaginary part is the measure for this determination. The delay circuit 511 electrically connected to the circuit for calculating delay correlation value 501 is further provided for storing the result of the calculation of delay correlation value of this first group of symbols (or the previous group).

After a period of time, the circuit for calculating delay correlation value 501 receives a later group of symbols, and calculates its delay correlation value. The circuit for setting parameters 513 electrically connected with the delay circuit 511 is to set at least two parameters, such as a first parameter and a second parameter, according to the delay correlation value of the previous group of symbols, where the first group of symbols is the previous group of symbols for the later retrieved symbols. The first parameter is the real part or imaginary part of the delay correlation value of the previous group of symbols, and the second parameter is the polarity of the delay correlation value of each group of symbols based on the adopted real part or imaginary part.

The mentioned circuit for determining to adopt real part or imaginary part 503 is to determine if the real part or imaginary part of the current delay correlation value is adopted according to the first parameter set by the circuit for setting parameters 513.

Next, the circuit for comparing polarity 505 obtains the real part or imaginary part value that is determined by the circuit for determining to adopt real part or imaginary part 503, and the second parameter indicating the polarity with plus or minus value is subsequently obtained by the circuit for setting parameters 513. As described above, the second parameter is obtained from the previous group of symbols, and used to determine the polarity of the delay correlation value of the currently received group of symbols. The circuit for comparing polarity 505 is now used to obtain the polarity difference between the second parameter and the adopted real part or imaginary part of the currently received symbols. That is to determine whether or not they have the same polarity. According to one of the embodiments, the determination is implemented by means of multiplication.

After the comparison of polarity, the result thereof is transmitted to the circuit for counting based on polarity 507 for further determination of the polarity of the applied communication system. This circuit for counting based on polarity 507, which is preferably implemented by a counter, is used to count the accumulated number of constantly-matched polarity of the communication system. In which, the counter is activated to count the number if the determined polarity is matched with the polarity of the applied communication system; otherwise, the counter is reset to zero if the polarities therebetween is not matched, and the system is noticed to repeat the procedures of receiving signals, calculating the delay correlation value, etc. Next, according to the output of the counter, the circuit for comparing with threshold 509 is used to compare the accumulated number with a threshold, and to determine whether or not it reaches the threshold. If the accumulated number reaches the threshold, that is the constantly-matched polarity is obtained, the start position of the symbol used for estimating channel of preamble of the packet-switching communication system is estimated; if the accumulated number not yet reaches the threshold, it is continued to monitor the output of counter.

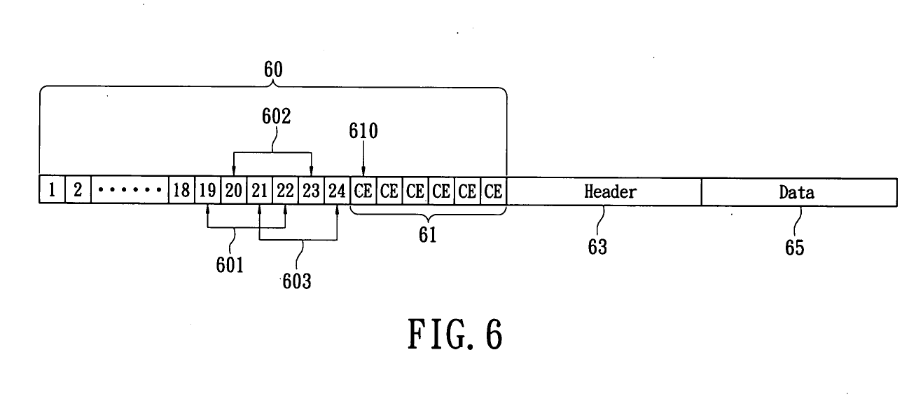

FIG. 6 shows a schematic diagram in order to determine the symbolic polarity through a delay correlation value. The packet format is in compliance with the exemplary packet-switching communication system. The packet is primarily formed with the preamble symbols 60 (includes the channel-estimation symbols 61), header 63 and data 65. In this example, the preamble symbols include 24 symbols for determining the polarity of this system, which has a reciprocal relevance with a specific polarity, in which the plurality of channel-estimation symbols 61 (6 are included in this example) are included.

According the example shown in FIG. 6, there is a specific relevance among the last few preamble symbols indicated with numerals 18, 19, 20, 21, 22, 23, 24. In order to obtain the polarity of the preamble symbols, the symbols are divided into a plurality of groups. For example, the symbols indicated with numerals 19 and 22 form as a group of symbols 601, the symbols indicated with numerals 20 and 23 form a group of symbols 602, and the symbols indicated with numerals 21 and 24 form another group of symbols 603. The related delay correlation values are calculated for each group of symbols by employing the formula (2).

Specifically, A1 is the multiplication of the delay correlation value of the group of symbols 601. Further, A2 is the multiplication of the delay correlation value of the group of symbols 602. Still further, A3 is the multiplication of the delay correlation value of the group of symbols 603. The polarity may be determined and shown as the combination of A1, A2 and A3. After that, the position of preamble symbols can be found by constant comparison of the polarity. In the meantime, the start position of the symbols of header can be estimated for precisely modulating the system's signals.

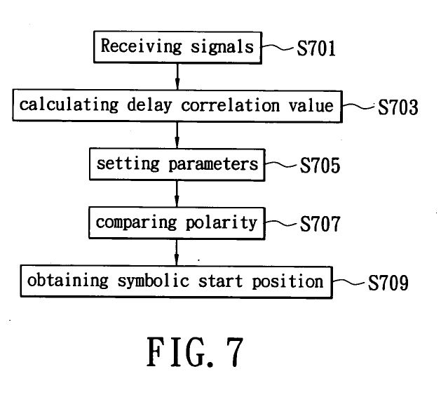

By means of the method for adaptively calculating symbolic start position embodied in above-mentioned circuit, the related flow chart is shown in FIG. 7. Step S701 shows the first step of receiving signals from a specific communication system. The received signals include a packet with a complete group of symbols. Next, the circuit for calculating delay correlation value is used to calculate the delay correlation value of the received symbols (step S703).

Next, the method goes to set the system's parameters. Firstly, it is to determine if the real part or imaginary part of the delay correlation value is adopted based on the delay correlation value of previous group of symbols. If it is a first group of symbols (no previous group is required), the absolute value of the real part or imaginary part of the delay correlation value is employed to determine which one is adopted. Next, a first parameter is set according to the result of the determination. More, the first parameter is used as the basis for determining if the real part or imaginary part is adopted. Then, the polarity of adopted real part or imaginary part is used to determine the polarity of the delay correlation value among the groups of symbols, and accordingly a second parameter is set.

The delay correlation value is calculated relied on the first group of symbols. In the meantime, there is no polarity determination, but only the absolute value of the real part and the imaginary part is compared for setting the first parameter. The delay correlation value is referred to formula (2), and its calculation result can be shown as a real part and an imaginary part.

In view of the mentioned scheme, in order to reduce the possible error determination, not only the first group of symbols is retrieved, but also to retrieve the system's parameters of the delay correlation value of previous group of symbols after a while later. After that, the parameters are used to compare with the delay correlation value of the current group of symbols so as to determine the system's polarity. The delay correlation values of both the current group of symbols and the coming group of symbols are calculated for determining the property of following group of symbols. More precisely, the real part or imaginary part of the delay correlation value of the current group of symbols is determined to be adopted according to the first parameter of the previous group of symbols, and the polarity of the delay correlation value of current group of symbols is determined according to the second parameter.

According to one of the embodiments for setting the first parameter, the real part of the delay correlation value is set as the first parameter if the absolute value of the real part of the delay correlation value for the first group of symbols is bigger than the imaginary part. This first parameter is used as the basis of determining the polarity by comparing with the real part of the delay correlation value of the current received group of symbols. Otherwise, the imaginary part is adopted if the absolute value of the real part of the delay correlation value for the first group of symbols is smaller than the imaginary part, and this imaginary part is set as the first parameter. After that, the second parameter can be set based on the polarity of the adopted real part or imaginary part (step S705).

After the procedure of setting the system's parameters, it's to determine whether the polarity of the current retrieved symbols is the same with the second parameter or not. Accordingly, it's determined if the polarity is in compliance with the specific communication system. In the preferred embodiment, the polarity represented in second parameter is compared with the polarity determined by the adopted real part or imaginary part for the current received group of symbols. After that, based on the polarity of the preamble symbols of the system, it is determined whether or not the polarity of the following received symbols is consistent with the default polarity of the system. If the polarity is consistent, a counter is activated to accumulate the number. The method will go to retrieve the next group of symbols, calculate its delay correlation value, determine to adopt the real part or imaginary part based on the first parameter for the previous group of symbols, and determine the polarity based on the second parameter since the accumulated number not yet reaches a predetermined threshold.

Otherwise, if the polarity is not consistent, the counter is reset as zero, and method will also go to the original steps, such as receiving the symbols, calculating delay correlation value, setting system's parameters, comparing the polarity (step S707). The above steps will be processed repeatedly until the number of counter reaches the threshold after accumulating the number as the polarity is consistent with the specific communication system. The position of the preamble symbols can be obtained since the accumulated number reaches the threshold, that is, the start position of the specific symbols is found (step S709).

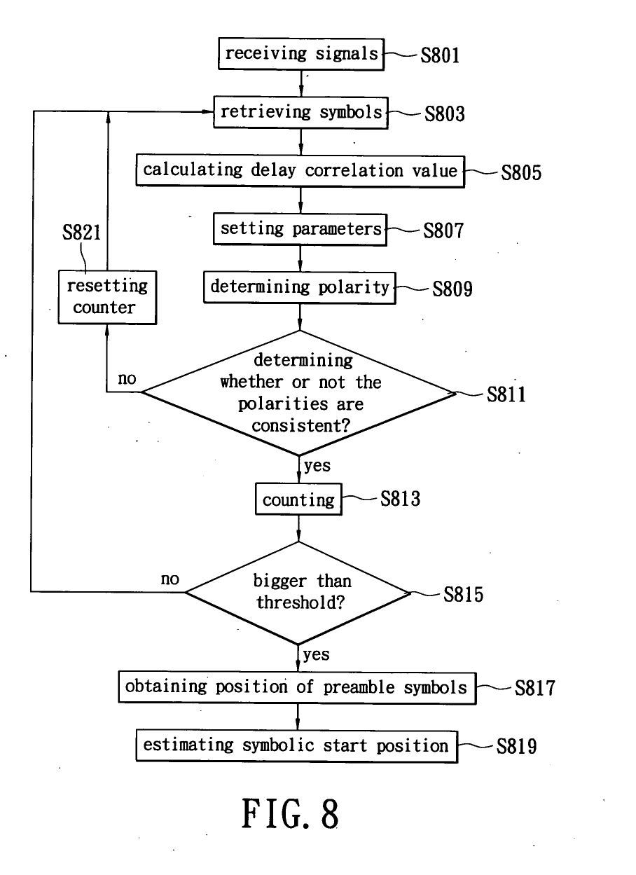

Further reference is made to FIG. 8, which is a detailed flow chart of the preferred embodiment of the claimed method. The method implements the frame synchronization circuit. Firstly, the method goes to receive the signals in a unit of packets by the circuit for calculating delay correlation value (step S801). The packet includes a complete group of symbols of the system. Next, the symbols therein are retrieved (step S803). Then, the circuit for calculating delay correlation value is used to calculate the delay correlation value for each group of symbols (step S805). The retrieved symbols have the first group of symbols and the subsequent symbols. A delay circuit is used to store the delay correlation value of previous group of symbols. Correspondingly, the first group of symbols is regarded as the previous group after a delay.

Next, the method goes to set the system's parameters having the first parameter and the second parameter in the example (step S807). If the previous group of symbols is the first group, the calculated delay correlation value won't be used for polarity determination, only to compare the absolute value of the real part and imaginary part. Reference is made to the formula (2). Next, the first parameter is set according to the comparison. The second parameter is set due to the polarity represented by the first parameter. It is determined to adopt the real part or imaginary part of the delay correlation value for the following group of symbols by referring to first parameter, and set next first parameter. Then the adopted real part or imaginary part is compared with the second parameter so as to determine the polarity.

Referring to the preferred embodiment, the real part is used to set the first parameter if the absolute value of the real part of delay correlation value for the first group of symbols is bigger than the absolute value of imaginary part. The imaginary part is used to set the first parameter if the absolute value of the real part is smaller than the absolute value of imaginary part, or else. The plus or minus value of the adopted real part or imaginary represents the polarity, and accordingly to set the second parameter.

In step S809, it is to determine the polarity of the delay correlation value calculated from the current group of symbols by comparing the value determined by the previously-adopted real part or imaginary part (first parameter) with the previously-set second parameter. For example, it's to determine the polarity through a multiplication operated between the second parameter and the real part or imaginary part of the delay correlation value of symbols.

After determining the polarity of the second parameter, it's to determine whether or not the polarity is consistent with the polarity property (that is the polarity of preamble symbols) of the applied communication system (step S11). If the polarities are consistent (yes), the counter is activated to count the number (step S813). If the polarities are not consistent (no), the counter is reset (step S821), and going to the step S803 for retrieving the next group of symbols, processing calculation of delay correlation value, setting parameters, and determining the polarity.

Step S815 is to continuously monitor the output of counter. Next, it is determined that whether or not the accumulated number as the determined polarity is successively consistent with the polarity property of the communication system reaches a predetermined threshold. That also means the delay correlation values of the successive symbols correspond with the format of the communication system. Particularly, the threshold is set for eliminating error, and estimating the position of preamble symbols accurately.

If the accumulated number not yet reaches the threshold (no), it is to continuously monitor the output of counter. The position of preamble symbols is obtained since the accumulated number reaches the default threshold (yes) (step S817). Thereby, the start position of the specific symbol is estimated (step S819).

In view of above description of the present invention, the present invention has the following advantages in comparison with the prior arts:

1. The present invention utilizes a control circuit, including a delay circuit and a circuit for setting parameters, to set the system's first parameter and second parameter as a basis for comparing the polarity of the preamble symbols, the estimation efficiency still keeps high as meeting higher frequency offset;

2. The present invention still keeps high estimation efficiency as the frequency offset approaching zero;

3. The delay correlation value is not only retrieved from the first group of symbols, but also from another adjacent group of symbols, which can prevent wrongful determination since big difference is occurred between the delay correlation value for setting system's parameters and the subsequent delay correlation value when the frequency offset doesn't converges fast enough.

In summation of the above description, the apparatus and method for adaptively calculating symbolic start position of the present invention uses the delay circuit and the circuit for setting parameters to retrieve the signals at different time. After setting parameters and comparing the polarity, the symbolic start position may be found, so the frame synchronization circuit won't be affected easily by the frequency offset.

While the invention has been described by means of a specification with accompanying drawings of specific embodiments, numerous modifications and variations could be made thereto by those skilled in the art without departing from the scope and spirit of the invention set forth in the claims.

What is claimed is:

1. An apparatus for adaptively calculating symbolic start position used to implement a frame synchronization circuit of a packet-switching communication system, the apparatus comprising:
a circuit for calculating delay correlation value, used to calculate a delay correlation value of a group of received symbols, and thereby to obtain a real part and an imaginary part of the value;
a control circuit electrically connected to the circuit for calculating delay correlation value, used to receive and store the delay correlation value calculated by the circuit for calculating delay correlation value, and then set at least two parameters;
a circuit for determining to adopt real part or imaginary part, electrically connected to the circuit for calculating delay correlation value and the control circuit, determining to adopt the real-part or the imaginary part of the delay correlation value based on the parameters set from the control circuit;
a circuit for comparing polarity, electrically connected to the circuit for determining to adopt real part or imaginary part and the control circuit, used to compare the parameters to the polarity of the currently received delay correlation value of the group of symbols;
a circuit for counting based on polarity, electrically connected to the circuit for comparing polarity, used to determine a result by comparison, and then determine whether or not the result is consistent with the packet-switching communication system, and next accumulating a number by a counter if the result of polarity comparison is consistent with the system; and
a circuit for comparing with threshold, electrically connected to the circuit for counting based on the polarity, used to determine whether or not the counter's accumulated value reaches a threshold, so as to determine the start position of a specific symbol of the packet-switching communication system.

2. The apparatus of claim 1, wherein the control circuit at least includes a delay circuit used for store the delay correlation value of the group of symbols, and a circuit for setting the parameters.

3. The apparatus of claim 2, wherein the circuit for setting parameters is used to set a first parameter based on the adopted real part or imaginary part, and set a second parameter by referring to the polarity of the real part or imaginary part responsive to the first parameter.

4. The apparatus of claim 3, wherein the circuit for comparing polarity is used to determine whether or not the polarity of the delay correlation value is consistent with the packet-switching communication system by means of multiplication based on the second parameter.

5. The apparatus of claim 3, wherein an absolute value of real part or imaginary part is used to determine whether or not the real part or the imaginary is adopted.

6. The apparatus of claim 1, wherein what the circuit for counting based on polarity acts comprises:
the counter is activated to accumulate the number if the polarity comparison result is consistent with the packet-switching communication system; and
the counter is reset to be zero if the polarity after comparison is not consistent with the system, and then it's to repeat the procedure of receiving the symbols and calculating their delay correlation value.

7. The apparatus of claim 1, wherein the specific symbol is a channel-estimation symbol.

8. The apparatus of claim 1, since the circuit for comparing with threshold is used to compare an output value of the counter to the threshold, wherein:
the start position of a channel-estimation symbol of the packet-switching communication system is estimated if the counter's value reaches the threshold after the counter accumulating the number with the same polarity;
and it's to monitor the counter continuously if the counter's value doesn't reach the threshold.

9. A method for adaptively calculating a start position of a series of symbols, comprising:
receiving a group of symbols;
calculating a delay correlation value of the symbols;
setting systematic parameters according to the delay correlation value, wherein a first parameter is set by referring an adopted real part or imaginary part of the delay correlation value; a second parameter is set by determining polarity of the delay correlation value based on the first parameter; and then receiving next group of symbols and calculating their delay correlation value;
determining polarity of the delay correlation value of the next group of symbols based on the first parameter and the second parameter, and similarly, a next first parameter and a next second parameter based on the next group of symbols are set for determining the characteristics of the next symbols;
determining whether or not the polarity of the next group of symbols is consistent with the characteristics of a packet-switching communication system;
accumulating a number since the polarity of next group of symbols is consistent with the communication system; and
obtaining the start position of a specific symbol of the communication system when the accumulated number with consecutive consistent characteristics reaches a threshold.

10. The method of claim 9, wherein the polarity is determined by a multiplication operated between the second parameter and the adopted real part or imaginary part of the symbols.

11. The method of claim 9, wherein the first parameter is set based on the absolute value of the real part or the imaginary part of the delay correlation value.

12. The method of claim 11, wherein the read part of the value is set as the first parameter if the absolute value of the real part is bigger than the imaginary part; or the imaginary part is set as the first parameter if the absolute value of the real part is smaller than the imaginary part.

13. The method of claim 11, wherein the second parameter is set based on the first parameter indicating the polarity of the real part or imaginary part.

14. The method of claim 9, wherein the step of determining the polarity further comprising:
if the polarity is consistent with the packet-switching communication system after determination, a counter is activated to accumulate the number;
if the polarity is not consistent with the communication system, the counter is reset, and repeating the steps of receiving the symbols, calculating the delay correlation value, setting the systematic parameters, and determining the polarity;
whereby to count the number with consecutive polarity.

15. The method of claim 9, wherein the specific symbol is a channel-estimation symbol.

16. A method for adaptively calculating a start position of a series of symbols, which is used to implement a frame synchronization of a packet-switching communication system, comprising:
receiving signals;
retrieving a previous group of symbols, and retrieving a next group of symbols after determining a polarity;
calculating a delay correlation value of the symbols;
setting systematic parameters having a first parameter and a second parameter, wherein the first parameter is configured according to the real part or imaginary part of the delay correlation value calculated from the previous group of symbols, and then the second parameter is configured by determining the polarity of the delay correlation value of the previous group of symbols based on the first parameter;
determining the real part or imaginary part adopted by the next group of symbols according to the first parameter;
comparing the next group of symbols to the polarity of second parameter based on the second parameter, and determining whether or not the result of comparison is consistent with the polarity of the packet-switching communication system; wherein if the polarity is consistent, a counter is activated to accumulate the number; if the polarity is not consistent, the counter is reset and going on retrieving further symbols; and
monitoring an output value of the counter and determining whether or not it reaches a threshold, wherein if the output value is not reaching the threshold, going on monitoring the output value of the counter until the output value reaches the threshold, so as to obtain the position of the preamble symbol of the system, thereby to estimate a start position of the system's specific symbol.

17. The method of claim 16, wherein the first parameter is configured according to the absolute value of the real part or imaginary part of the delay correlation value of the symbols.

18. The method of claim 17, wherein the real part of the delay correlation value is set as the first parameter if the absolute value of the real part is bigger than the imaginary part; the imaginary part is set as the first parameter if the absolute value of the real part is smaller than the imaginary part.

19. The method of claim 16, wherein the multiplication calculated between the second parameter and the real part or imaginary part of the delay correlation value of the symbols is used to determine the polarity.

20. The method of claim 16, wherein the specific symbol is a channel-estimation symbol.
